(19) United States
(12) Patent Application Publication
(10) Pub. No.: US 2023/0229894 A1
(43) Pub. Date: Jul. 20, 2023

(54) METHOD AND APPARATUS FOR COMPRESSION AND TRAINING OF NEURAL NETWORK

(71) Applicant: INTELLECTUAL DISCOVERY CO., LTD., Seoul (KR)

(72) Inventors: Yongjo AHN, Seoul (KR); Jongseok LEE, Seoul (KR)

(21) Appl. No.: 18/002,195

(22) PCT Filed: Jun. 25, 2021
(86) PCT No.: PCT/KR2021/008005

§ 371 Date: Dec. 16, 2022

(30) Foreign Application Priority Data
Jun. 25, 2020 (KR) 10-2020-0078071
Jul. 2, 2020 (KR) 10-2020-0081483

(51) Int. Cl. G06N 3/0495; H04N 19/42; G06N 3/08

(52) U.S. Cl. CPC G06N 3/0495; H04N 19/42; G06N 3/08

(57) ABSTRACT

A neural-network-based signal processing method and apparatus according to the present invention may: receive a bitstream including information about a neural network model, wherein the bitstream includes at least one neural network access unit; obtain information about the at least one neural network access unit from the bitstream; and reconstruct the neural network model on the basis of the information about the at least one neural network access unit.

### TECHNICAL FIELD

The present disclosure relates to a method and apparatus for compressing a neural network. Furthermore, the present disclosure relates to a neural network training and inference method and apparatus.

### BACKGROUND ART

Video images are compressed and coded by removing temporal and spatial redundancy and redundancy between viewpoints, which may be transmitted through a communication line or stored in a form suitable for a storage medium.

### DISCLOSURE

### Technical Problem

An object of the present disclosure is to improve coding efficiency of video signals. In addition, the present disclosure is intended to improve coding efficiency of neural networks. In addition, the present disclosure is intended to improve training and inference performance of neural networks.

### Technical Solution

A neural network-based signal processing method and apparatus according to the present disclosure may receive a bitstream including information on a neural network model, herein, the bitstream includes at least one neural network access unit, may obtain information on the at least one neural network access unit from the bitstream, and may reconstruct the neural network model based on the information on the at least one neural network access unit.

In a neural network-based signal processing method and apparatus according to the present disclosure, at least one neural network access unit may include a plurality of neural network layers.

In a neural network-based signal processing method and apparatus according to the present disclosure, the information on the at least one neural network access unit may include at least one of model information specifying the neural network model, layer information of the at least one neural network access unit, a model parameter set indicating parameter information of the neural network model, a layer parameter set representing parameter information of neural network layers or compressed neural network layer information.

In a neural network-based signal processing method and apparatus according to the present disclosure, the layer information may include at least one of a number, a type, a location, an identifier, an arrangement order, a priority, whether to skip compression, node information of the neural network layers, or whether there is a dependency between the neural network layers.

In a neural network-based signal processing method and apparatus according to the present disclosure, the model parameter set may include at least one of a number of the neural network layers, entry point information specifying a starting position in the bitstream corresponding to the neural network layers, quantization information used for compression of the neural network model, or type information of the neural network layers.

In a neural network-based signal processing method and apparatus according to the present disclosure, the entry point information may be individually included in the model parameter set according to the number of the neural network layers.

In a neural network-based signal processing method and apparatus according to the present disclosure, the layer parameter set may include at least one of a parameter type of a current neural network layer, a number of sub-layers of the current neural network layer, entry point information specifying a starting position in the bitstream corresponding to the sub-layers, quantization information used for compression of the current neural network layer or difference quantization information indicating a difference value with the quantization information used for the compression of the current neural network model.

In a neural network-based signal processing method and apparatus according to the present disclosure, the compressed neural network layer information may include at least one of weight information, bias information or normalization parameter information.

### Advantageous Effects

According to an embodiment of the present disclosure, coding efficiency of a video signal can be improved. In addition, according to an embodiment of the present disclosure, coding efficiency of a neural network can be improved. In addition, according to an embodiment of the present disclosure, training and inference performance of a neural network can be improved.

### DESCRIPTION OF DRAWINGS

FIG. 1 is a conceptual diagram illustrating a schematic flow of compression and reconstruction of a neural network model according to an embodiment of the present disclosure.

FIG. 2 is a diagram for explaining in detail a compression concept of a neural network model as an embodiment according to the present disclosure.

FIG. 3 is a diagram for explaining in detail the reconstruction concept of a neural network model as an embodiment according to the present disclosure.

FIG. 4 illustrates a bitstream structure of a neural network generated through compression of a neural network model as an embodiment according to the present disclosure.

FIG. 5 is a diagram illustrating a payload structure of a neural network access unit as an embodiment according to the present disclosure.

FIG. 6 is a diagram illustrating another embodiment of a payload structure of a neural network access unit as an embodiment according to the present disclosure.

FIG. 7 is a diagram conceptually illustrating information included in a compressed neural network layer as an embodiment according to the present disclosure.

FIG. 8 is a diagram illustrating a structure of a model parameter set (MPS) as an embodiment according to the present disclosure.

FIG. 9 is a diagram illustrating a structure of a layer parameter set (LPS) as an embodiment according to the present disclosure.

FIG. 10 is a diagram conceptually illustrating a bitstream structure of a compressed neural network model as an embodiment according to the present disclosure.

FIG. 11A and FIG. 11B are diagrams illustrating a flow of a deep learning network and an input/output of a layer in the deep learning network as an embodiment according to the present disclosure.

FIG. 12A and FIG. 12B are diagrams illustrating a flow of a deep learning network and an input/output of a layer in the deep learning network as an embodiment according to the present disclosure.

FIG. 13A and FIG. 13B are diagrams illustrating a flow of a deep learning network as an embodiment according to the present disclosure.

FIG. 14 is a diagram for explaining a method of generating residual weights for weight training of a deep learning network as an embodiment according to the present disclosure.

FIG. 15 is a diagram illustrating a process of optimizing weights using an error tensor encoder and an error tensor decoder as an embodiment according to the present disclosure.

FIG. 16 is a diagram illustrating a process of optimizing weights using an error map encoder and an error map decoder as an embodiment according to the present disclosure.

FIG. 17A and FIG. 17B are diagrams illustrating training and inference process of a deep learning network as an embodiment according to the present disclosure.

FIG. 18A and FIG. 18B are diagrams illustrating training and inference process of a deep learning network using encoded/decoded images as an embodiment according to the present disclosure.

FIG. 19A and FIG. 19B are diagrams illustrating training and inference process of a deep learning network using encoding/decoding of images and feature tensors as an embodiment according to the present disclosure.

FIG. 20A and FIG. 20B are diagrams illustrating training and inference process of a deep learning network using a feature tensor on which the deep learning network is performed, as an embodiment according to the present disclosure.

FIG. 21 is a diagram illustrating a training process of a deep learning network using encoding/decoding of a feature tensor and an error tensor as an embodiment according to the present disclosure.

### BEST MODE FOR DISCLOSURE

A neural network-based signal processing method and apparatus according to the present disclosure may receive a bitstream including information on a neural network model, herein, the bitstream includes at least one neural network access unit, may obtain information on the at least one neural network access unit from the bitstream, and may reconstruct the neural network model based on the information on the at least one neural network access unit.

In a neural network-based signal processing method and apparatus according to the present disclosure, the at least one neural network access unit may include a plurality of neural network layers.

In a neural network-based signal processing method and apparatus according to the present disclosure, the information on the at least one neural network access unit may include at least one of model information specifying the neural network model, layer information of the at least one neural network access unit, a model parameter set indicating parameter information of the neural network model, a layer parameter set representing parameter information of neural network layers or compressed neural network layer information.

In a neural network-based signal processing method and apparatus according to the present disclosure, the layer information may include at least one of a number, a type, a location, an identifier, an arrangement order, a priority, whether to skip compression, node information of the neural network layers, or whether there is a dependency between the neural network layers.

In a neural network-based signal processing method and apparatus according to the present disclosure, the model parameter set may include at least one of a number of the neural network layers, entry point information specifying a starting position in the bitstream corresponding to the neural network layers, quantization information used for compression of the neural network model, or type information of the neural network layers.

In a neural network-based signal processing method and apparatus according to the present disclosure, the entry point information may be individually included in the model parameter set according to the number of the neural network layers.

In a neural network-based signal processing method and apparatus according to the present disclosure, the layer parameter set may include at least one of a parameter type of a current neural network layer, a number of sub-layers of the current neural network layer, entry point information specifying a starting position in the bitstream corresponding to the sub-layers, quantization information used for compression of the current neural network layer or difference quantization information indicating a difference value with the quantization information used for the compression of the current neural network model.

In a neural network-based signal processing method and apparatus according to the present disclosure, the compressed neural network layer information may include at least one of weight information, bias information or normalization parameter information.

### MODE FOR DISCLOSURE

Referring to a diagram attached in this description, an embodiment of the present disclosure is described in detail so that a person with ordinary skill in the art to which the inventions pertain may easily carry it out. However, the present disclosure may be implemented in a variety of different shapes and is not limited to an embodiment which is described herein. In addition, a part irrelevant to description is omitted and a similar diagram code is attached to a similar part through the description to clearly describe the present disclosure in a diagram.

In this description, when a part is referred to as being ‘connected to’ other part, it includes a case that it is electrically connected while intervening another element as well as a case that it is directly connected.

In addition, in this description, when a part is referred to as ‘including’ a component, it means that other components may be additionally included without excluding other components, unless otherwise specified.

In addition, a term such as first, second, etc. may be used to describe various components, but the components should not be limited by the terms. The terms are used only to distinguish one component from other components.

In addition, in an embodiment on a device and a method described in this description, some configurations of the device or some steps of the method may be omitted. In addition, an order of some configurations of the device or some steps of the method may be changed. In addition, another configuration or another step may be inserted in some configurations of the device or some steps of the method.

In addition, some configurations or some steps in a first embodiment of the present disclosure may be added to a second embodiment of the present disclosure or may be replaced with some configurations or some steps in a second embodiment.

In addition, the components shown in the embodiments of the present disclosure are shown independently to indicate different characteristic functions, and do not mean that each component is composed of separate hardware or one software component unit. That is, for convenience of description, each component is listed as each component, and at least two components of each component may be combined to form one component, or one component may be divided into a plurality of components to perform a function. The integrated and separated embodiments of each of these components are also included in the scope of the present disclosure without departing from the essence of the present disclosure.

First, the terms used in the present application will be briefly described as follows.

The decoding apparatus (Video Decoding Apparatus), which will be described later, may be a civil security camera, a civil security system, a military security camera, a military security system, a personal computer (PC), a notebook computer, a portable multimedia player (PMP), a wireless communication terminal, a smart phone, a apparatus included in a server terminal such as a TV application server and a service server, and may mean a user terminal such as various apparatus, a communication apparatus such as a communication modem for performing communication with a wired/wireless communication network, a memory for storing various programs and data for decoding an image or performing an inter prediction or intra prediction for decoding, various apparatus equipped with microprocessor, etc. for executing programs and calculating and controlling them.

In addition, an image encoded as a bitstream by an encoder may be transmitted to an image decoding apparatus through real-time or non-real-time wired/wireless communication networks such as the Internet, local area wireless communication networks, wireless LAN networks, WiBro networks, mobile communication networks, or through various communication interfaces such as cables, Universal Serial Bus (USB), etc., decoded, reconstructed as an image, and reproduced. Alternatively, the bitstream generated by the encoder may be stored in memory. The memory may include both volatile memory and non-volatile memory. In the present specification, the memory may be represented as a recording medium storing the bitstream.

In general, a video may be composed of a series of pictures, and each picture may be divided into a coding unit such as a block. In addition, a person with ordinary knowledge in the technical field to which this embodiment belongs may understand that the term ‘a picture’ described below may be used by replacing it with another term having an equivalent meaning such as ‘an image’ or ‘a frame’. In addition, it will be understood by those of ordinary skill in the art to which this embodiment pertains that the term ‘a coding unit’ may be substituted for and used with other terms having the same meaning, such as ‘a unit block’ and ‘a block’.

Hereinafter, exemplary embodiments of the present disclosure will be described in detail with reference to the accompanying drawings. In describing the present disclosure, redundant description of the same components will be omitted.

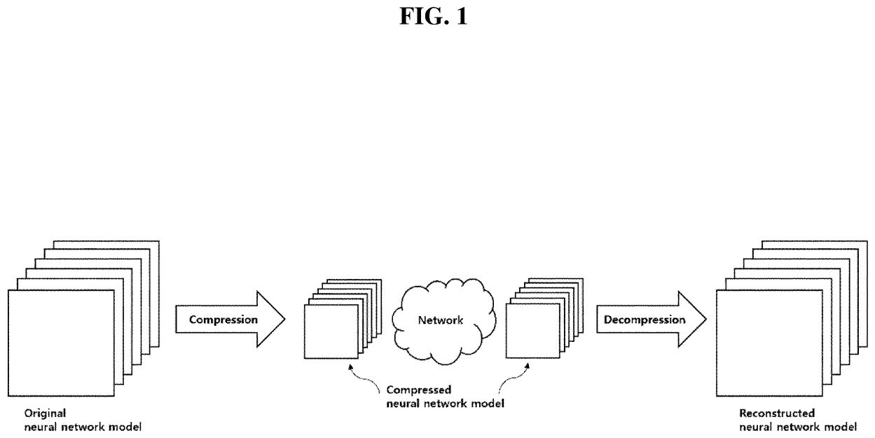

FIG. 1 is a conceptual diagram illustrating a schematic flow of compression and reconstruction of a neural network model according to an embodiment of the present disclosure.

Referring to FIG. 1, a compressed neural network model may be derived by performing compression using a pre-defined compression method on a neural network model including at least one network model. The compressed neural network model may be transmitted using a wired or wireless network or stored in a storage device.

The transmitted or stored compressed neural network model may be reconstructed into a neural network model corresponding to an original neural network model by using a pre-defined reconstruction method corresponding to the pre-defined compression method.

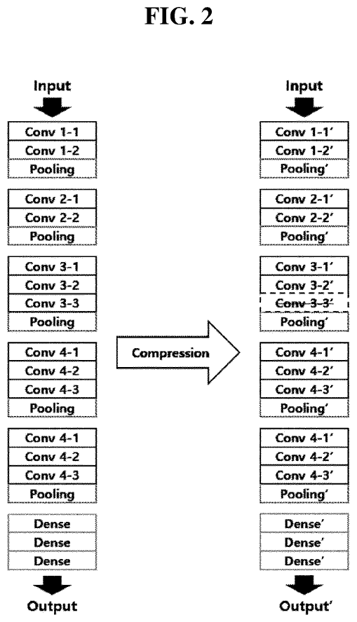

FIG. 2 is a diagram for explaining in detail a compression concept of a neural network model as an embodiment according to the present disclosure. FIG. 2 shows an embodiment of compressing a VGG-16 model, which is one of the representative neural network models for image processing.

Referring to FIG. 2, in performing compression on a neural network model, at least one layer included in the conventional neural network model may be removed through a quantization process.

In an embodiment of FIG. 2, Conv 3-3 layer may be removed in a compression process (or quantization process) of the neural network model. Conv 3-3 layer may be positioned between a pooling layer and Conv 3-2 layer. As an example, Conv 3-3 layer may be removed because it does not perform a relatively significant role.

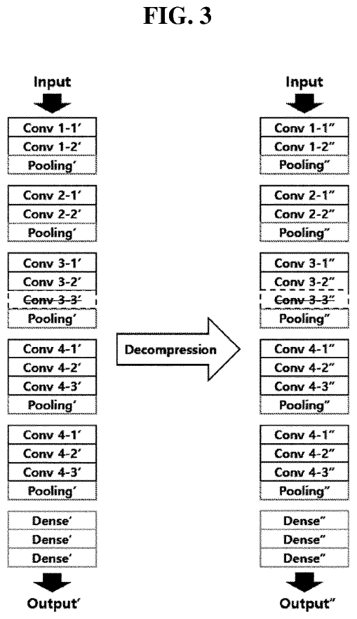

FIG. 3 is a diagram for explaining in detail the reconstruction concept of a neural network model as an embodiment according to the present disclosure. FIG. 3 shows an embodiment of reconstructing a compressed VGG-16 model.

FIG. 3 illustrates a case in which a corresponding neural network model is reconstructed when one or more layers are removed through the quantization process in the compression process of the neural network model according to the embodiment of FIG. 2 described above.

According to an embodiment of the present disclosure, when there is a layer already removed in the compression process, a neural network model from which the corresponding layer is removed may be output even through the reconstruction process.

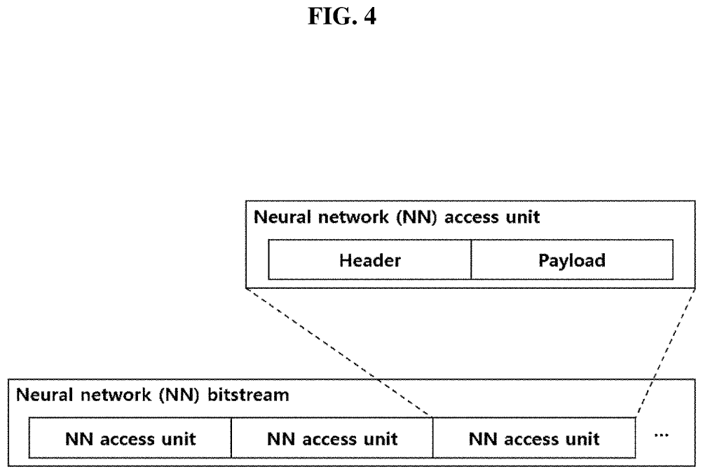

FIG. 4 illustrates a bitstream structure of a neural network generated through compression of a neural network model as an embodiment according to the present disclosure.

Referring to FIG. 4, the neural network model may be expressed in the form of a compressed bitstream, and in the present disclosure, the bitstream may be referred to as a neural network bitstream. The neural network bitstream may include one or a plurality of neural network access units. Here, the neural network access unit represents an access unit that is transmitted or received through a wired or wireless network.

The neural network access unit may include a header and/or a payload as shown in FIG. 4. Here, the header may include higher-level information such as a type, a size, and layer information (or layer-related information) of the access unit, and the payload may include lower-level information about the compressed neural network model. As an example, an access unit may include both a header and a payload, and may include only a header excluding the payload or only the payload excluding the header. The configuration of the access unit may vary depending on whether the access unit has a variable size, and a detailed description thereof will be described later. Higher-level information is merely a concept distinct from lower-level information, and layer-related information and/or sub-layer-related information may also be included in the payload.

Also, in one embodiment, the neural network access unit may have a variable size. When the neural network access unit has a variable size, a start position of the access unit may be determined according to a pre-defined start code, or an end position of the access unit may be determined according to a pre-defined end code. The access unit may have either the start code or the end code, or some access units may have both the start code and the end code. Alternatively, for example, a neural network bitstream may be divided into access units having a specific pre-defined size.

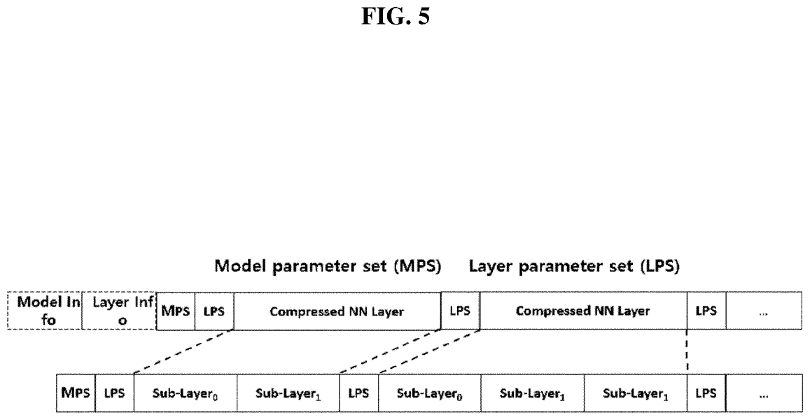

FIG. 5 is a diagram illustrating a payload structure of a neural network access unit as an embodiment according to the present disclosure.

Referring to FIG. 5, the payload of the neural network access unit may include at least one of model information, layer information, model parameter set (MPS), layer parameter set (LPS), or compressed neural network layer information. Here, the model information may represent information indicating (or specifying) one of various pre-defined neural network models (or neural network access units). In this case, 0 or more specific numbers may be mapped (or assigned) to the various pre-defined neural network models.

In addition, the layer information may be information about at least one of a number, a type, a position, an identifier, an arrangement order, a priority, independency/dependency between layers, whether to skip or node-related information of layers included in a current neural network model (or current access unit). The type of layer may represent information indicating one of various pre-defined layers. In this case, a specific pre-defined number may be mapped to the various pre-defined layers.

The example of FIG. 5 assumes that model information and layer information are included in the payload of the neural network access unit, but is not necessarily limited thereto. For example, model information and/or layer information may be included in a header of the neural network access unit. In addition, in the example of FIG. 5, it is assumed that the model parameter set is included in the payload of the neural network access unit, but is not necessarily limited thereto. For example, a model parameter set may be included in a header of the neural network access unit.

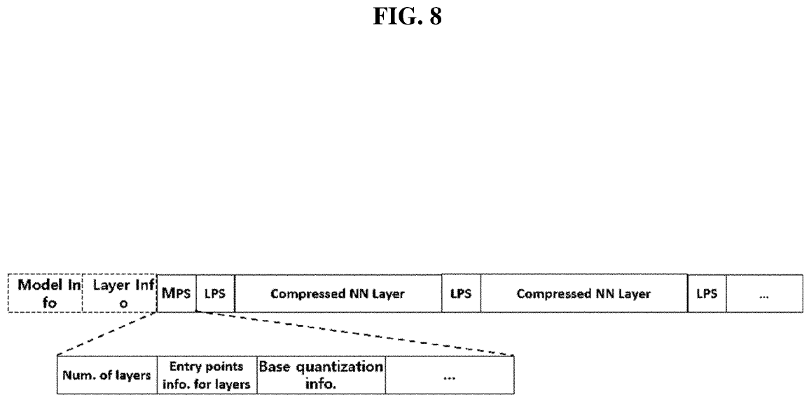

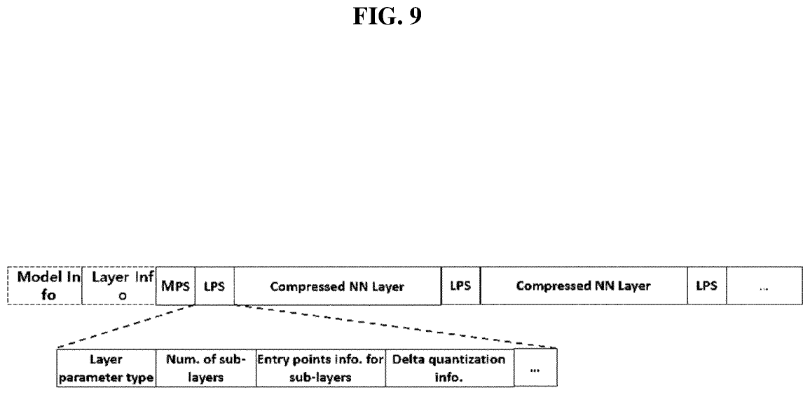

Hereinafter, the model parameter set will be described in detail with reference to FIG. 8, and the layer parameter set will be described in detail with reference to FIG. 9 later.

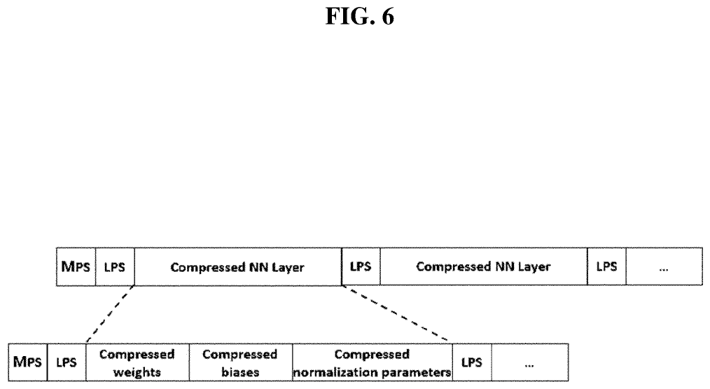

As shown in FIG. 5, a compressed neural network layer may include at least one sub-layer. In this case, the number of sub-layers included in the compressed neural network layer may be variable. In this disclosure, the compressed neural network layer may be referred to as a neural network layer. Also, the sub-layer may include information of the compressed neural network layer described later in FIG. 6. A method of reducing an amount of information through prediction and compensation using previously transmitted sub-layer information may be applied to the sub-layer information.

FIG. 6 is a diagram illustrating another embodiment of a payload structure of a neural network access unit as an embodiment according to the present disclosure.

Referring to FIG. 6, each layer constituting a neural network model may include at least one of weight information, bias information, or a normalization parameter according to the number of nodes constituting the corresponding layer.

According to an embodiment of the present disclosure, a compressed neural network layer may include at least one of compressed weight information, compressed bias information, or compressed normalization parameter information. As an embodiment, a layer of the neural network model may include at least one of a weight, a bias, or a normalization parameter, and quantization may be performed on each of the weight, bias, and normalization parameter included in the layer of the neural network model. Compression of the quantized weights, biases, and normalization parameters may be performed according to a pre-defined entropy coding method.

In addition, the amount of information may be reduced by performing prediction using weights, biases, and parameters of adjacent layers before performing quantization, and compression may be performed on a difference value derived based on a predicted value using at least one of a quantization method or an entropy coding method.

In the example of FIG. 6, it is assumed that the model parameter set is included in the payload of the neural network access unit, but is not necessarily limited thereto. For example, a model parameter set may be included in a header of the neural network access unit.

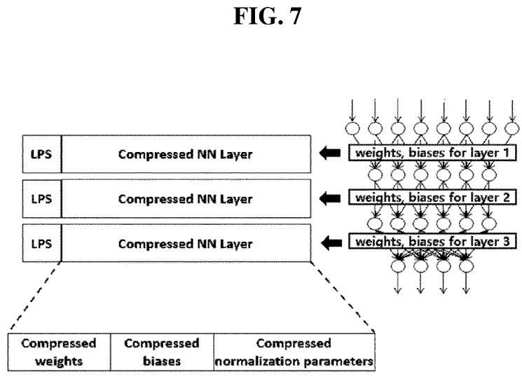

FIG. 7 is a diagram conceptually illustrating information included in a compressed neural network layer as an embodiment according to the present disclosure.

Referring to FIG. 7, a compressed neural network layer may include at least one of compressed weight information, compressed bias information, or compressed normalization parameter information.

As an embodiment, as a compression method used for compression of at least one of weight information, bias information, or normalization parameter information, methods such as prediction, transform, or quantization may be used. At least one compression method among prediction, transform, or quantization may be used.

FIG. 8 is a diagram illustrating a structure of a model parameter set (MPS) as an embodiment according to the present disclosure.

Referring to FIG. 8, a model parameter set includes parameter information related to a compressed neural network model. Specifically, the model parameter set may include at least one of the number of neural network layers, information on an entry point specifying a start position in a bitstream corresponding to each of neural network layers, quantization information used for compression of a current neural network model (In the present disclosure, it may be referred to as basic quantization information) or type information of each of neural network layers.

In this case, entry point information specifying a start position of a bitstream corresponding to each layer may be individually signaled according to the number of neural network layers, and the decoder may decode the received information.

FIG. 9 is a diagram illustrating a structure of a layer parameter set (LPS) as an embodiment according to the present disclosure.

Referring to FIG. 9, a layer parameter set includes parameter information related to each neural network layer in a compressed neural network model. Specifically, the layer parameter set may include at least one of a type of layer parameter, the number of sub-layers of a current neural network layer, information on an entry point specifying a starting position in a bitstream corresponding to each sub-layer, quantization information used for compression of a current neural network layer or difference quantization information indicating a difference value with quantization information used for compression of the current neural network model.

According to an embodiment of the present disclosure, additional parameter information may be included in a layer parameter set according to a layer parameter type.

For example, when the layer parameter type is a convolution layer, information about the number of weights and/or shapes of the weights may be additionally included in the layer parameter set. Here, a shape of a weight may be represented by at least one piece of information among the number of channels of the weight, a height of the weight, or a width of the weight.

Also, when the layer parameter type is a convolution layer, information related to padding may be additionally included in the layer parameter set. The information related to padding may include at least one of an input padding size, an input padding method, an output padding size, or an output padding method. If the corresponding information is not included, predetermined information may be used for padding. Here, padding means adding a specific value to input and/or output data. A size of the padding may include size information expressed as two integers (or positive integers) for each dimension of data, such as horizontal direction (i.e., left, right) or vertical direction (up, down). Alternatively, padding may be performed by including one piece of information for each dimension and applying the same size to both sides.

For example, if the number of dimensions of data is 4, a total of 8 pieces of size information may be additionally included in the layer parameter set. Also, as a padding method, information on a padding method such as zero padding or copy padding may be transmitted (or included). Here, zero padding indicates a method of filling a padding region with a value of 0, and copy padding indicates a method of filling a padding region with a data value closest to the padding region. Also, information related to padding may further include padding information for input data or output data, and in this case, the same padding method may be applied using the same information.

Also, when the layer parameter type is a convolution layer or a pooling layer, information on a convolution sample unit may be additionally included in the layer parameter set. Here, the convolution sample unit may include the same number of information as the number of dimensions of the input data or twice as much information as the number of dimensions of the input data. For example, when the value of the convolution sample unit information is 2 (i.e., one piece of information is included), a convolution operation may be performed in units of 2 samples in a vertical and/or horizontal direction. If the convolution operation is performed in units of 2 samples, when a position where a current convolution operation is performed is (0,0), the next operation position may be (2,0). Alternatively, for example, if the value of the convolution sample unit information includes two pieces of information (or values) such as (2, 1), the convolution operation may be performed in units of 2 samples in the horizontal direction and the convolution operation may be performed in units of 1 sample in the vertical direction.

In addition, payload information of compressed neural network layers may be signaled according to a signaled number of sub-layers. Also, the layer parameter type may indicate a specific layer type among pre-defined layer types, and an integer value greater than or equal to 0 may be mapped to the pre-defined layer types. As an embodiment, a value indicating a corresponding layer may be signaled by assigning a specific value to a pre-defined layer type, such as 0 in the case of a convolution layer and 1 in the case of a pooling layer.

In addition, the difference quantization information indicates a difference value between basic quantization information used for compression of a current neural network model of a model parameter set signaled prior to a layer parameter set and quantization information used for compression of a current layer. As an example, the difference quantization information may be signaled after being classified into an absolute value and sign information of a corresponding difference value.

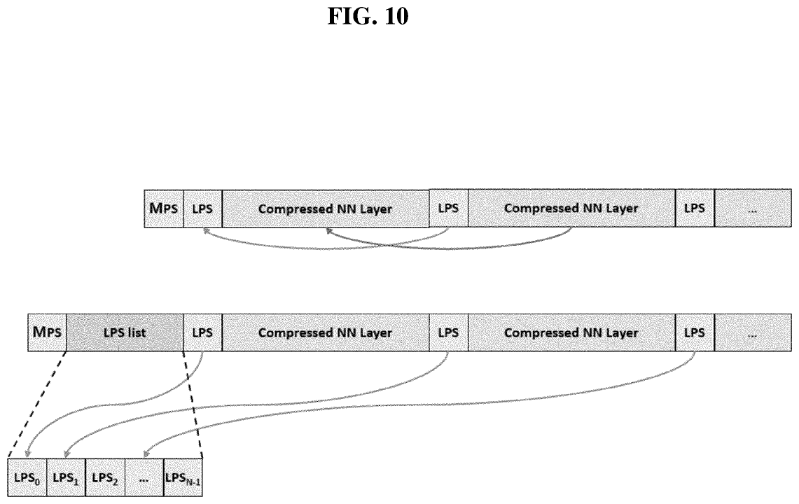

FIG. 10 is a diagram conceptually illustrating a bitstream structure of a compressed neural network model as an embodiment according to the present disclosure.

Referring to FIG. 10, in a bitstream of a compressed neural network model, a compressed neural network layer (or payload of a layer) and/or a layer parameter set may refer to respectively previously signaled compressed neural network layer information and/or parameter sets. In other words, structural similarity may exist between the layers constituting the neural network model. For example, various similarities may exist, such as the number of sub-layers included in a layer, a type of sub-layers, the number of neurons constituting a layer, and the similarity of connections.

Accordingly, according to an embodiment of the present disclosure, a layer parameter set including information related to a neural network layer based on this similarity may refer to a previous layer parameter set. In addition, payload information of the compressed neural network layer may also refer to previously signaled payload information.

Also, as an embodiment, a list of layer parameter sets (i.e., an LPS list) for a layer constituting a current neural network model may be configured. The LPS list may include one or more layer parameter sets, and an identifier (ID) corresponding to each layer parameter set in the LPS list may be assigned.

At this time, in transmitting each layer parameter set in one compressed neural network model bitstream, a method of obtaining layer parameter set information using only identifier information corresponding to the previously signaled list of layer parameter sets may be used.

In this way, when a list of layer parameter sets is configured and signaling is performed using layer parameter set identifier information in a following bitstream (or payload), repetitive signaling of layer parameter sets can be reduced.

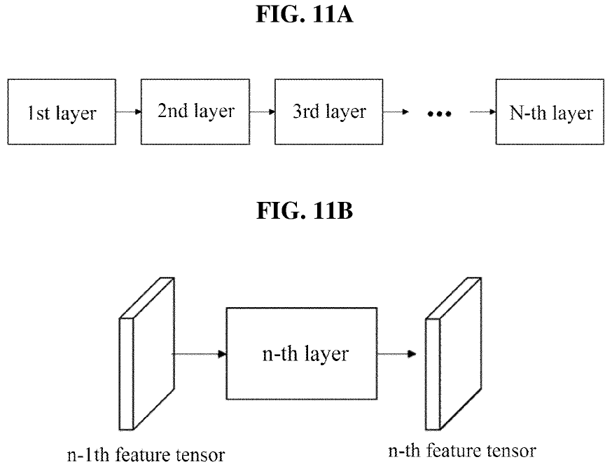

FIG. 11a and FIG. 11b are diagrams illustrating a flow of a deep learning network and an input/output of a layer in the deep learning network as an embodiment according to the present disclosure.

FIG. 11a shows a forward flow of a deep learning network. The deep learning network may have N layers, and each layer may be one of a convolution layer, a deconvolution layer, a pooling layer, a skip layer, a summation layer, or a difference layer.

FIG. 11b shows input/output of an n-th layer (i.e., the n-th layer). Referring to FIG. 11b, an input of the n-th layer may be a feature tensor which is an output of an n−1-th layer. Here, a tensor represents a form of one-dimensional or more than one-dimensional data.

An n-th feature tensor may be generated through the n-th layer, and the generated n-th feature tensor may be input to an n+1-th layer.

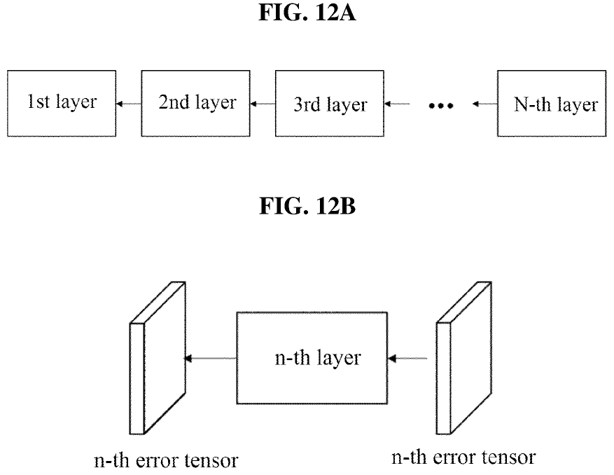

FIG. 12a and FIG. 12b are diagrams illustrating a flow of a deep learning network and an input/output of a layer in the deep learning network as an embodiment according to the present disclosure. Specifically, FIG. 12a shows a reverse flow of a deep learning network, and FIG. 12b shows input/output of an n-th layer in the reverse flow.

Referring to FIG. 12a, the reverse flow of the deep learning network may occur in the process of training a weight of each layer. Reverse propagation of an error from a last layer of the deep learning network to a first layer (or in the direction of the first layer) is called back-propagation, and during the back-propagation process, error tensors may be generated in each layer. Also, referring to FIG. 12b, the n-th layer may receive an n-th error tensor and generate an n−1-th error tensor.

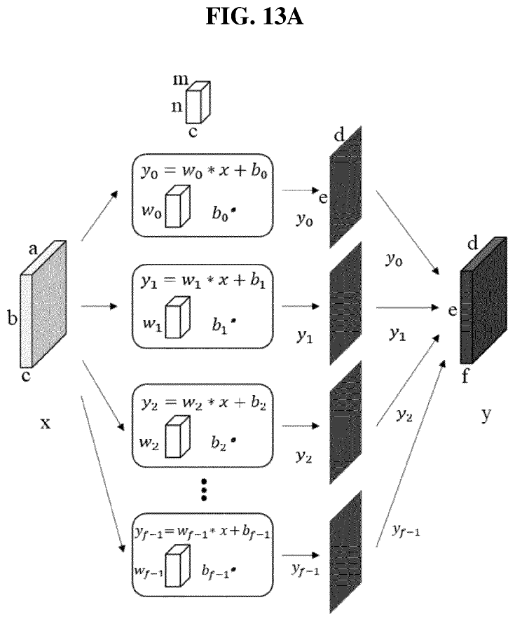

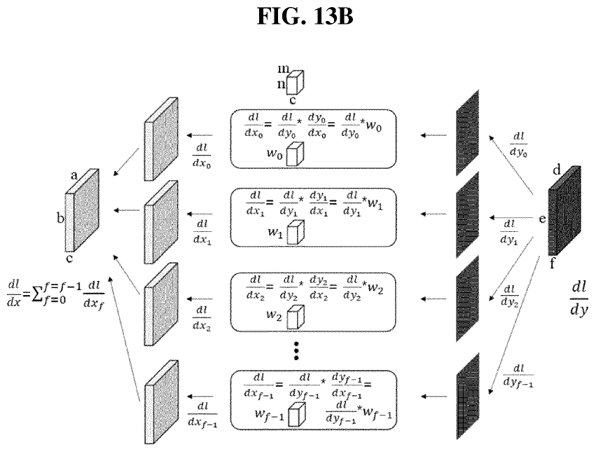

FIG. 13a and FIG. 13b are diagrams illustrating a flow of a deep learning network as an embodiment according to the present disclosure. Specifically, FIG. 13a shows forward flow of the n-th layer of the deep learning network, and FIG. 13b shows the reverse flow of the n-th layer of the deep learning network.

Referring to FIG. 13a, input (x) may be an input tensor of a deep learning network or an n−1 th feature tensor. And, the output (y) may be the output tensor of the network or the nth feature tensor. Input (x) and output (y) may be data having the same horizontal, vertical, and channel.

Alternatively, the input (x) and the output (y) may have sizes that are adaptively changed according to the type of layer. For example, when the layer is a convolutional layer, the horizontal and/or vertical lengths may be reduced according to the horizontal and/or vertical lengths of weights, respectively. Alternatively, for example, when the current layer is a pooling layer, the horizontal and/or vertical lengths may be halved.

In an embodiment, the number of weights (w) and/or biases (b) of the n-th layer may be equal to the number of channels (f) of an output feature map. For example, an output having less than f channels may be generated by omitting a specific number of weights and/or biases according to a predetermined application method. A convolution operation is performed on the input (x) based on the weight (w_f) and the bias (b_f) is added, thereby an output (y_f) may be generated. Output y_f may represent each channel of output y.

Referring to FIG. 13b, in the reverse flow, an n-th layer may receive an n-th error tensor from an n+1th layer and output an n−1th error tensor to an n−1th layer. At this time, the input error tensor dl/dy may be separated into error maps for each channel, such as dl/d_{y0}, dl/d_{y1}, dl/dy_{f-1}.

Here, each error map may form a pair with a weight (wf). That is, one error map may be mapped to one weight. Then, an optimizer may update weights paired with the error map using an input feature tensor and an error map. Also, the error map may form a pair with a bias. Then, the optimizer may use the error map to update the bias paired with the error map.

For each separated error map, convolution may be performed based on the weight, and thus an error tensor for each weight may be generated. Finally, an n−1 th error map (dl/dx) may be generated by summing the error tensors for all weights. The generated n−1 th error map (dl/dx) may be input to an n−1 th layer.

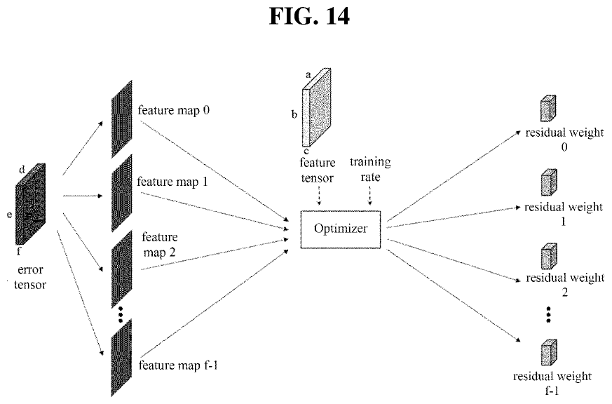

FIG. 14 is a diagram for explaining a method of generating residual weights for weight training of a deep learning network as an embodiment according to the present disclosure.

Referring to FIG. 14, an optimizer may generate one residual weight by taking one channel of the error tensor, a feature tensor, a training rate as inputs. That is, the optimizer may generate (or derive) residual weights applied to weights of each channel using one channel, feature tensor, training rate of an error map, and update the weights based on the generated residual weights.

In one embodiment, the error map may necessarily be required to be input separately for each channel. Also, an entire tensor (or an entire feature tensor) may be required as a feature tensor.

Also, the training rate may be a predetermined fixed value, or the value may be adaptively adjusted by reflecting statistical characteristics of the residual weight in the training process in the optimizer.

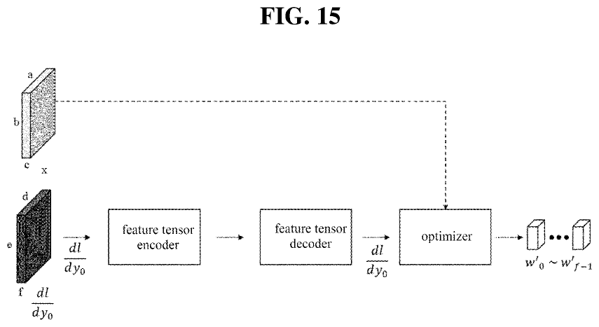

FIG. 15 is a diagram illustrating a process of optimizing weights using an error tensor encoder and an error tensor decoder as an embodiment according to the present disclosure.

Referring to FIG. 15, a position (or component) where an error tensor is generated and an optimizer may be different, and in this case, transmission of the error tensor may be necessarily required.

However, the error tensor generated in one image has a large capacity, and in the case of a video, the capacity is very large. Therefore, the amount of data may be reduced by encoding the error tensor, compressing it in the form of a bitstream, and transmitting it. Also, when the error tensor generated by the GPU is transmitted to an external storage device, compression encoding in the form of a bitstream may be applied.

In one embodiment, the optimizer, as a receiver in the form of a server, may receive error tensors transmitted from a plurality of transmitters and generate residual weights using the received error tensors. In this case, the method described above with reference to FIG. 14 may be applied. The generated residual weight may be transmitted to the transmitter and added to the weight of the transmitter.

The error tensor encoder/decoder may use an image encoder/decoder, respectively. Alternatively, the error tensor encoder/decoder may be implemented as a component included in each image encoder/decoder, or the image encoder/decoder may be implemented as a component included in each error tensor encoder/decoder.

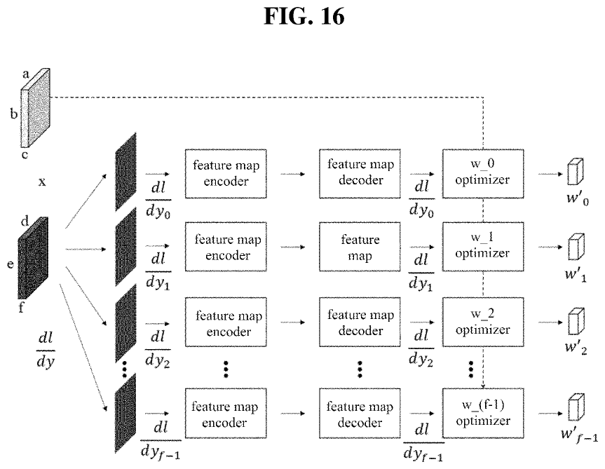

FIG. 16 is a diagram illustrating a process of optimizing weights using an error map encoder and an error map decoder as an embodiment according to the present disclosure.

Referring to FIG. 16, an error map may be individually mapped to weights and/or biases as one channel of an error tensor. One error map may be used to update one weight.

Therefore, when updating only one or some weights is required, a corresponding error map divided into error maps from an error tensor may be transmitted. As an example, a bitstream generated by the error map encoder may include a channel number of the error map. In addition, the bitstream generated by the error map encoder may include at least one of horizontal length information, vertical length information, channel number information, and weight number information of weights for generating the error map.

The error map encoder/decoder may use an image encoder/decoder, respectively. Alternatively, the error map encoder/decoder may be implemented as a configuration included in each image encoder/decoder, or the image encoder/decoder may be implemented as a configuration included in each error map encoder/decoder.

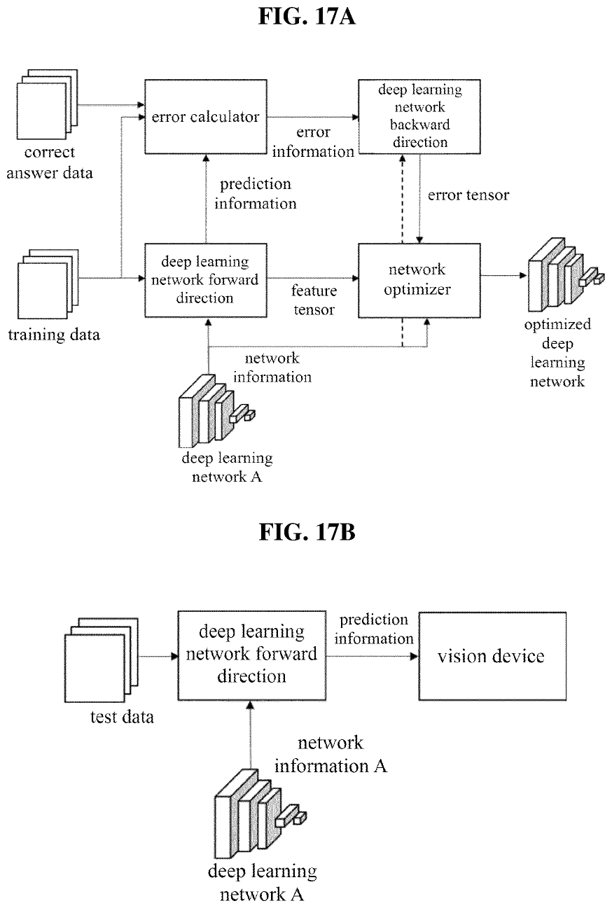

FIG. 17a and FIG. 17b are diagrams illustrating training and inference process of a deep learning network as an embodiment according to the present disclosure.

Referring to FIG. 17a, the deep learning network training unit may receive at least one of training data, correct answer data, and deep learning network information. Here, the training data may be data acquired through various sensors, and for example, the training data may include at least one of image, video, voice, text, or 3D data.

In addition, the correct answer data represents correct answer data for a value that the deep learning network is to predict as a pair with the training data. For example, if the deep learning network is a network for region segmentation of an image, the correct answer data may be a segmented binary image. Alternatively, in the case of a network for detecting an object, the correct answer data may be coordinates and/or a size of the object in the image. Alternatively, in the case of a network for voice recognition, the answer data may be text information corresponding to voice.

The deep learning network information may include a structure and/or parameters of the deep learning network. Here, the deep learning network structure may be information related to types of layers of the deep learning network and/or connections between layers. In addition, the deep learning network structure may include information about sampling layers, such as downsampling or upsampling between layers. Here, sampling may be sampling for nodes and/or sampling for connectivity. In addition, the deep learning network structure may further include information on sampling frequency.

Referring to FIG. 17b, the deep learning network inference unit may receive test data. An inference process may be performed based on the test data, and prediction information may be input to a vision device.

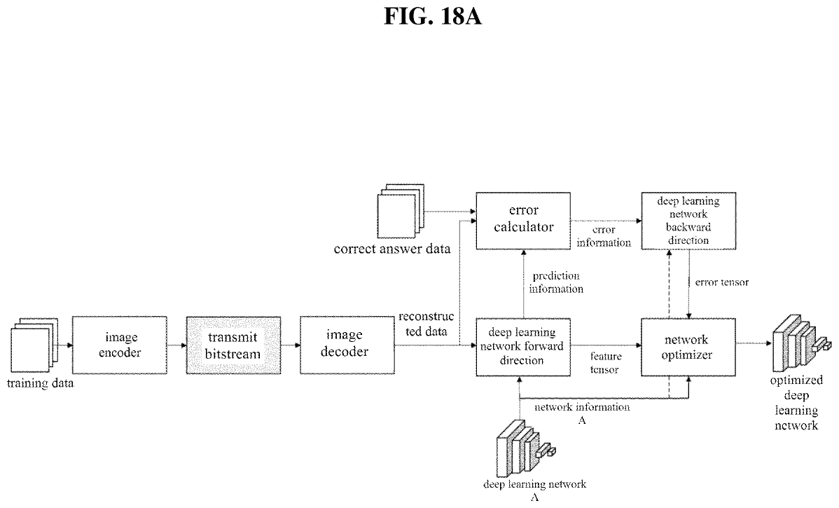

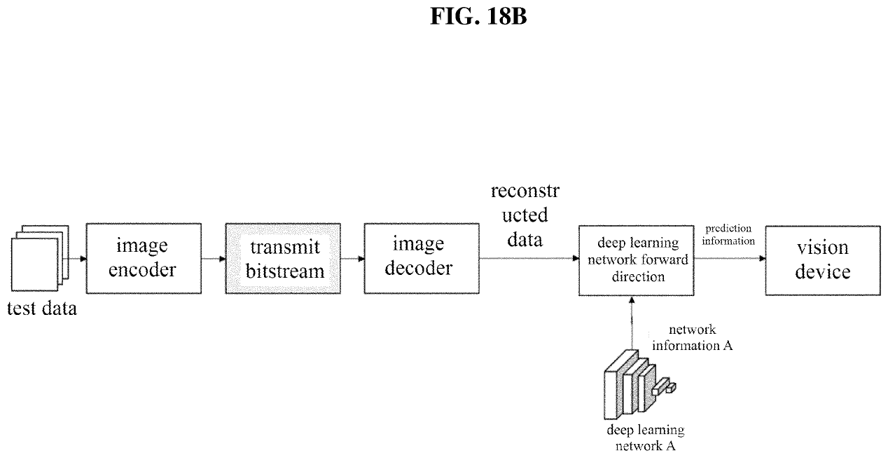

FIG. 18a and FIG. 18b are diagrams illustrating training and inference process of a deep learning network using encoded/decoded images as an embodiment according to the present disclosure.

Referring to FIG. 18a, the previously described deep learning network training unit of FIG. 17a may receive compressed/reconstructed data as training data through an image encoder/decoder. Redundant descriptions with those previously described in FIG. 17 will be omitted. Specifically, the training data may be compressed and encoded by an image encoder and transmitted in the form of a bitstream. The video decoder may reconstruct data by performing decoding on the received bitstream and transmit the reconstructed data to the deep learning network.

Referring to FIG. 18b, the deep learning network inference unit due to encoding/decoding may receive compressed/deconstructed data as test data through an image encoder/decoder. At this time, since the accuracy of the vision device of the inference unit is expected to decrease, a deep learning network training unit including an encoding/decoding process may be required to reflect these characteristics.

In addition, depending on the transmission/reception environment, the quality of the received image may be deteriorated, and the image decoder may extract main information in advance and transmit it to the vision device in consideration of the decrease in accuracy of the vision device due to the deterioration in image quality. Here, the main information may include at least one of a quantization parameter, a picture division structure, an intra-prediction direction, a motion vector, a reference structure, prediction information, or merge information.

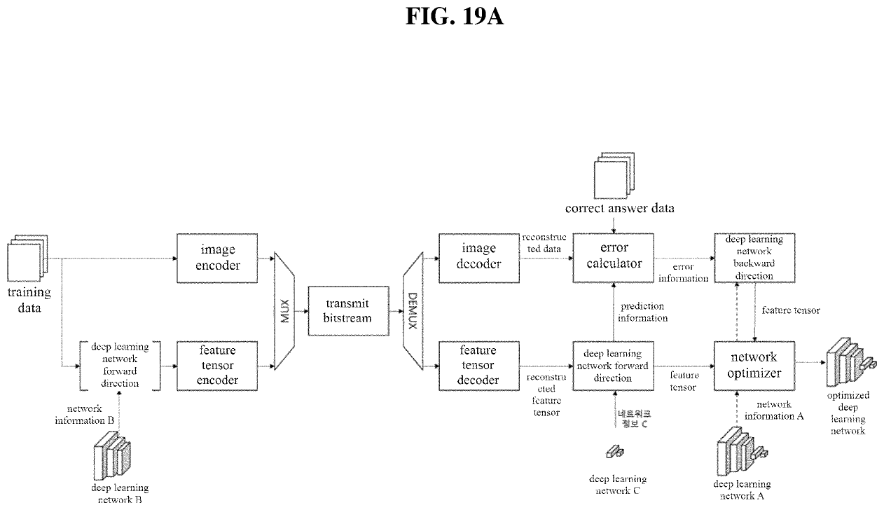

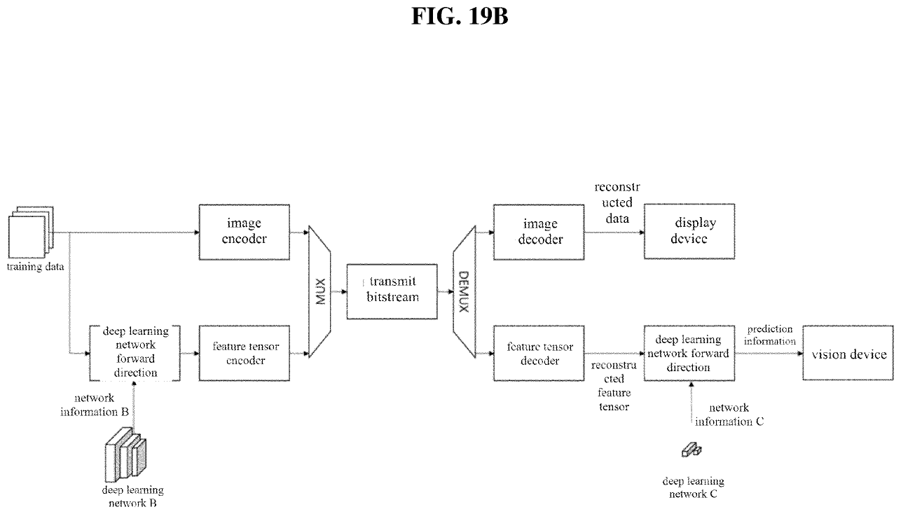

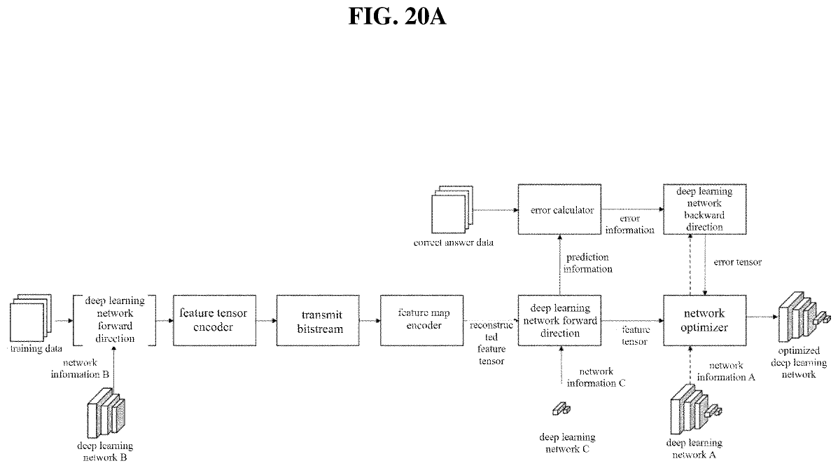

FIG. 19a and FIG. 19b are diagrams illustrating training and inference process of a deep learning network using encoding/decoding of images and feature tensors as an embodiment according to the present disclosure.

Referring to FIG. 19, the deep learning network training unit and inference unit according to the present embodiment may perform encoding/decoding of feature tensors output through partial deep learning networks along with encoding/decoding of images. Redundant descriptions with those previously described in FIGS. 17 and 18 will be omitted.

When the forward flow of the deep learning network is performed together with the encoded/decoded video decoder, computational complexity may increase rapidly. In order to solve this problem, it is possible to reduce the computational complexity of the training unit/inference unit by performing some forward flow of the deep learning network in the server, encoding the output intermediate feature tensor, and transmitting the output together with the image.

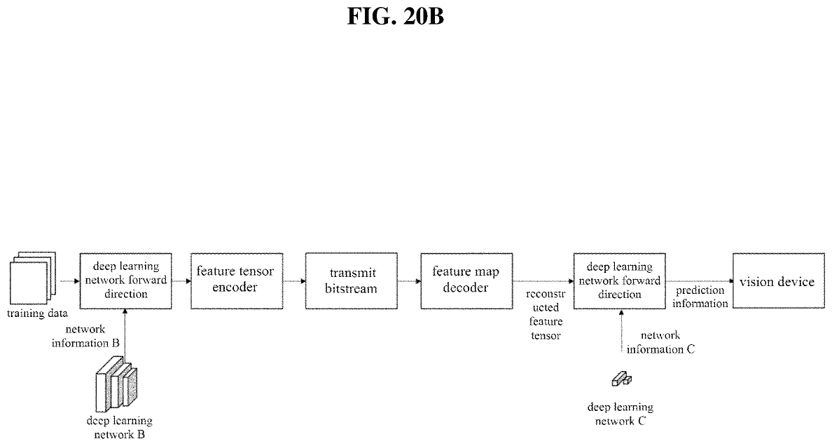

FIG. 20a and FIG. 20b are diagrams illustrating training and inference process of a deep learning network using a feature tensor on which the deep learning network is performed, as an embodiment according to the present disclosure.

Referring to FIG. 20a, the previously described deep learning network training unit of FIG. 17a may receive feature tensors that have passed through the deep learning network as training data. Redundant descriptions with those previously described in FIG. 17 will be omitted.

According to an embodiment of the present disclosure, a serious personal information problem may occur when an encoded/decoded image is used in a deep learning network training unit and inference unit. For example, most of the images generated during the treatment process of patients in hospitals contain key personal information, and as image data is frequently used in hospitals for the purpose of applying (or utilizing) deep learning, this privacy infringement problem has become a highlighted problem.

Therefore, for learning and inference of a deep learning network that solves this problem, feature tensors (or feature maps) generated through partial deep learning without encoding/decoding of images may be used.

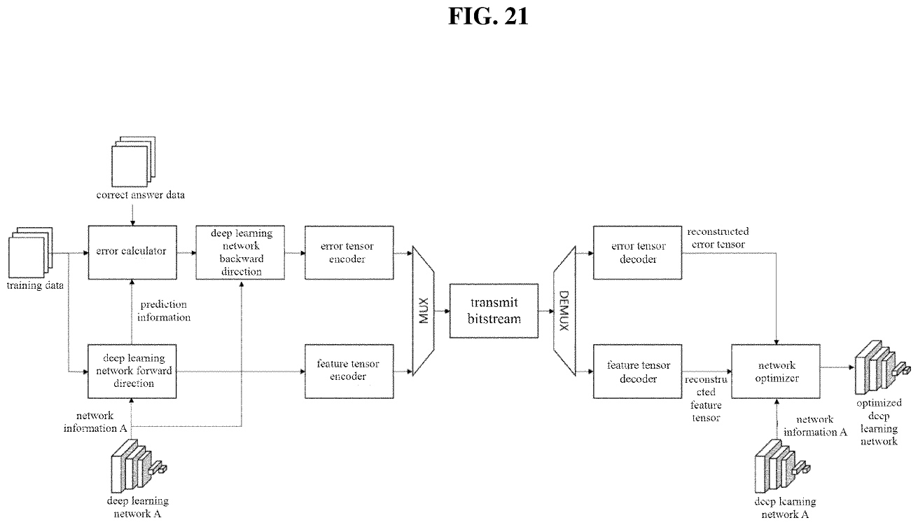

FIG. 21 is a diagram illustrating a training process of a deep learning network using encoding/decoding of a feature tensor and an error tensor as an embodiment according to the present disclosure.

Referring to FIG. 21, an error tensor may be generated in a process of training a deep learning network through a backpropagation algorithm. Since the error tensor is generally generated individually for each training data, a large amount of error tensor is generated and used in the case of deep learning using a very large amount of data.

In general, the case of storing the error tensor or using the error tensor is a case of training using an average error rather than performing an update based on individual error data. In deep learning applications such as image recognition, the amount of data used to obtain the average error is one of the most important factors in improving accuracy. In this case, the amount of memory available in the GPU may be the amount of data used for error averaging. GPUs may be trained with networks that show high accuracy because they may process quickly and have a large memory size. The deep learning network training unit of FIG. 21 may encode/decode the error tensor and store it in an external memory, thereby improving complexity and having an advantage in terms of cost.

The embodiments described above are those in which elements and features of the present invention are combined in a predetermined form. Each component or feature should be considered optional unless explicitly stated otherwise. Each component or feature may be implemented in a form not combined with other components or features. It is also possible to configure an embodiment of the present invention by combining some components and/or features. The order of operations described in the embodiments of the present invention may be changed. Some components or features of one embodiment may be included in another embodiment, or may be replaced with corresponding components or features of another embodiment. It is obvious that claims that do not have an explicit citation relationship in the claims can be combined to form an embodiment or can be included as new claims by amendment after filing.

An embodiment according to the present invention may be implemented by various means, for example, hardware, firmware, software, or a combination thereof. For implementation by a hardware, implementation may be performed by one or more ASICs(Application Specific Integrated Circuits), DSPs(Digital Signal Processors), DSPDs(Digital Signal Processing Devices), PLDs(Programmable Logic Devices), FPGAs(Field Programmable Gate Arrays), general processors, controllers, microcontrollers, microprocessors, etc.

In addition, in the case of implementation by firmware or software, an embodiment of the present invention may be implemented in the form of a module, procedure, function, etc. that performs the functions or operations described above, and may be recorded on a recording medium readable through various computer means. Here, the recording medium may include program commands, data files, data structures, etc. alone or in combination. Program instructions recorded on the recording medium may be those specially designed and configured for the present invention, or those known and usable to those skilled in computer software. For example, recording media include magnetic media such as hard disks, floppy disks and magnetic tapes, optical media such as CD-ROMs (Compact Disk Read Only Memory) and DVDs (Digital Video Disks), floptical It includes hardware devices specially configured to store and execute program instructions, such as magneto-optical media, such as a floptical disk, and ROM, RAM, flash memory, etc. Examples of program instructions may include high-level language codes that may be executed by a computer using an interpreter or the like as well as machine language codes generated by a compiler. These hardware devices may be configured to act as one or more software modules to perform the operations of the present invention, and vice versa.

In addition, an apparatus or terminal according to the present invention may be driven by a command that causes one or more processors to perform the functions and processes described above. For example, such instructions may include interpreted instructions, such as script instructions such as JavaScript or ECMAScript instructions, or executable code or other instructions stored on a computer readable medium. Furthermore, the device according to the present invention may be implemented in a distributed manner over a network, such as a server farm, or may be implemented in a single computer device.

In addition, a computer program (also known as a program, software, software application, script or code) loaded into a device according to the present invention and executing the method according to the present invention includes a compiled or interpreted language or a priori or procedural language. It can be written in any form of programming language, and can be deployed in any form, including stand-alone programs, modules, components, subroutines, or other units suitable for use in a computer environment. A computer program does not necessarily correspond to a file in a file system. A program may be in a single file provided to the requested program, or in multiple interacting files (e.g., one or more modules, subprograms, or files that store portions of code), or parts of files that hold other programs or data. (e.g., one or more scripts stored within a markup language document). A computer program may be deployed to be executed on a single computer or multiple computers located at one site or distributed across multiple sites and interconnected by a communication network.

It is apparent to those skilled in the art that the present invention can be embodied in other specific forms without departing from the essential characteristics of the present invention. Accordingly, the foregoing detailed description should not be construed as limiting in all respects and should be considered illustrative. The scope of the present invention should be determined by reasonable interpretation of the appended claims, and all changes within the equivalent scope of the present disclosure are included in the scope of the present disclosure.

### INDUSTRIAL AVAILABILITY

The present disclosure may be used for a neural network-based video compression method and apparatus.

1. A neural network-based signal processing method, the method comprising:
receiving a bitstream including information on a neural network model, the bitstream including at least one neural network access unit;
obtaining information on the at least one neural network access unit from the bitstream; and
reconstructing the neural network model based on the information on the at least one neural network access unit.

2. The method of claim 1,
wherein the at least one neural network access unit includes a plurality of neural network layers.

3. The method of claim 2,
wherein the information on the at least one neural network access unit includes at least one of model information specifying the neural network model, layer information of the at least one neural network access unit, a model parameter set indicating parameter information of the neural network model, a layer parameter set representing parameter information of neural network layers or compressed neural network layer information.

4. The method of claim 3,
wherein the layer information includes at least one of a number, a type, a location, an identifier, an arrangement order, a priority, whether to skip compression, node information of the neural network layers, or whether there is a dependency between the neural network layers.

5. The method of claim 3,
wherein the model parameter set includes at least one of a number of the neural network layers, entry point information specifying a starting position in the bitstream corresponding to the neural network layers, quantization information used for compression of the neural network model, or type information of the neural network layers.

6. The method of claim 5,
wherein the entry point information is individually included in the model parameter set according to the number of the neural network layers.

7. The method of claim 3,
wherein the layer parameter set includes at least one of a parameter type of a current neural network layer, a number of sub-layers of the current neural network layer, entry point information specifying a starting position in the bitstream corresponding to the sub-layers, quantization information used for compression of the current neural network layer or difference quantization information indicating a difference value with the quantization information used for the compression of the current neural network model.

8. The method of claim 3,
wherein the compressed neural network layer information includes at least one of weight information, bias information or normalization parameter information.

9. A neural network-based signal processing apparatus, the apparatus comprising:
a processor controlling the signal processing apparatus; and
a memory combined with the processor and storing data,
wherein the processor receives a bitstream including information on a neural network model,
wherein the bitstream includes at least one neural network access unit,
wherein the processor obtains information on the at least one neural network access unit from the bitstream, and
wherein the processor reconstructs the neural network model based on the information on the at least one neural network access unit.
